(19) United States
(12) Patent Application Publication
(10) Pub. No.: US 2006/0004658 A1
(43) Pub. Date: Jan. 5, 2006

(54) Method of processing credit payments at delivery

(76) Inventors: Wunchun Chau, Redmond, WA (US); William Pittman, Redmond, WA (US)

Correspondence Address: AZ PATENT LAW FIRM, P.O. Box 1921, Beltsville, MD, 20704, US

(21) Appl. No.: 11/160,575

(22) Filed: Jun. 29, 2005

Related U.S. Application Data
(60) Provisional application No. 60/585,134, filed on Jul. 2, 2004.

(51) Int. Cl. G06Q 40/00

(52) U.S. Cl. 705/40

(57) ABSTRACT

A method of processing signature-required payment using a handheld device with a wireless access capability is disclosed. When a consumer buys goods from a seller, the seller and consumer agree on the amount of payment and acceptable payment species. The delivery person of the shipper who delivers the goods on behalf of the seller processes the payment using customer's credit/debit card and a cellular phone or handheld device at the door of the customer. Upon approval of the payment, the delivery person releases the goods to the customer.

### CROSS REFERENCE TO RELATED APPLICATIONS

This patent application claims the priority from the provisional application 60/585,134 accorded with a filing date of Jul. 2, 2004.

### FIELD OF INVENTION

The present invention relates generally to payment method, and more particularly to payment method at delivery.

### BACKGROUND OF THE INVENTION

Cash-on-delivery (“COD”) is a payment method well known in the shipping industry. When a customer makes a purchase from a seller, they agree on the deal, payment method, and acceptable payment species. The seller then prepares a package for the goods with a shipping label showing payment method and acceptable payment species in the form of cash, official check, money order, and certified personal checks. The seller then has a shipping company deliver the goods to the customer. A delivery person of the shipping company, who may be a driver, collects money in an acceptable payment species designated on the shipping label, and gives the goods to the customer. At the end of the business day, the delivery person gives the money to the shipper who will ultimately forward the money to the seller pursuant to their agreement.

This payment leaves little room for any dispute in payment authorization. While this method is workable, it is not widely used because it is difficult and inconvenient for the customer to have cash, certified or official checks, or money order in the exact amount at the time and the place of delivery. If a seller accepts personal check, the seller may have to collect on bad checks if a customer has insufficient fund or later decides to stop payment.

For these reasons, COD has never gained popularity in sales transactions. Nowadays, most payments are made using the information on credit accounts in remote purchase transactions. When a customer buys goods from a seller, the customer provides the seller credit card information, expiration date and an authorization. The seller then processes the payment without seeing the actual card (therefore known as “card-not-present payments”) and processes the payment at the time of shipment. However, this method also has problems. If the customer cancels the transaction, the seller has to refund the money from its receivable account (known as “charge back”). From the beginning of the electronic payment age, charge-backs have been the unwanted reality for on-line and MOTO (What is it?) sellers.

A seller accepting card-not-present payments is particularly vulnerable to outright fraud. Since the seller does not have any sales slip containing customer signature, the customer may deny that he or she has purchased and received the goods. It is difficult to prove oral payment authorization. Therefore, resolution of this type of dispute often ends up with a refund of the payment to the customer. Moreover, such customer disputes are very costly to the seller. Not only does the seller lose the value of the goods it shipped, it also faces monetary penalties if its charge-back rates exceed the limit set by credit card companies. Charge-back penalties for fraudulent transactions are typically in the range of $15-$30. The seller often has to bear the expenses in conducting internal investigations and charge-back management. In some cases, if a seller continues to have excessively a high rate on charge-back occurrences, it can lose its card acceptance privilege. Loss of this privilege is a deadly blow for the seller since signature-based credit cards and debit cards are dominant payment vehicles in our society and many customers will not place purchase orders with sellers who does not accept credit cards and/or debit cards.

Most shippers now have wireless networks and notebook computer pads that they use for tracking shipping. Recent innovations allow shippers to take cardholders' signatures and transfer them in real-time to the Internet for tracking. Therefore, it is possible to build a payment system for accepting payment by credit cards and debit cards at delivery. The existing technologies can be modified to accept credit and PIN-based debit cards, collect signatures, print receipts and process payment transactions.

### SUMMARY OF THE INVENTION

The primary object of the present invention is to provide a payment method, which can be used at the time of delivery to process signature-based payments.

Another object of the present inventions is to provide a payment method, which is immune from dispute in payment authorization.

The present invention is a payment method that utilizes existing payment network, wireless technology, and client and server technology, and encryption technology to process payment using a signature-based card or a check at the time of delivery. The card may be credit card, debit card, and EBT. If the method is used to process a signed check, the method may be used to verify fund availability and present an electronic check real time.

There are several advantages in the payment method. In one aspect, the delivery person can swipe customer cards with a card reader to conduct “card-present” payment transactions, and therefore the costs of the payment transactions are lower because the payment methods are qualified for lower retail rates which are about 1% lower than the e-commerce rate at which the sellers pay to the credit card association. Another advantage of the payment method is that the seller can accept low-cost tenders such as PIN-based debit cards and electronic checks.

The cost of the payment transaction using debit cards is usually a fixed fee which is about $0.25 per transaction instead of paying a cost proportional to the payment amount. Moreover, debit card and EBT card payments involves two-factor authentication. The user is required not only to use the card to swipe it through the card reader, but also provide a secret PIN. This two-factor authentication allows the shipper to accept payments with the minimal risk on behalf of the seller. The payment method also provides a piece of mind to consumers who do not trust sellers present in the Internet because they make payment authorization only when the goods are to be delivered to them. The method also provides a convenient payment method for both seller and customers. The method can help sellers prevent the fraudulent sales transactions by imposters and reduce the amounts of penalties in charge-back claims. The method also provides a new revenue stream for the shippers who participate in the payment method. The method also helps shippers reduce the loss from un-collectible funds such as bad checks. Once sellers have the incentive to use such virtual POS system because it is cheap and secure, they may pass some of the saved money back to the consumers to encourage them to use.

Those and other aspects of the present invention will become apparent to those skilled in the art after a reading of the following detailed description of the invention together with the following drawings.

### BRIEF DESCRIPTION OF THE DRAWINGS

FIG. 1 is a flowchart showing the basic steps of processing a payment using the payment method according to one embodiment of the present invention;

FIG. 2 is a block diagram showing the detailed components of the handheld payment device and the necessary network systems used in payment method according to the present invention; and

FIG. 3 is a flowchart showing the detail steps from processing a card-present payment to releasing the goods.

### DETAILED DESCRIPTION OF THE INVENTION

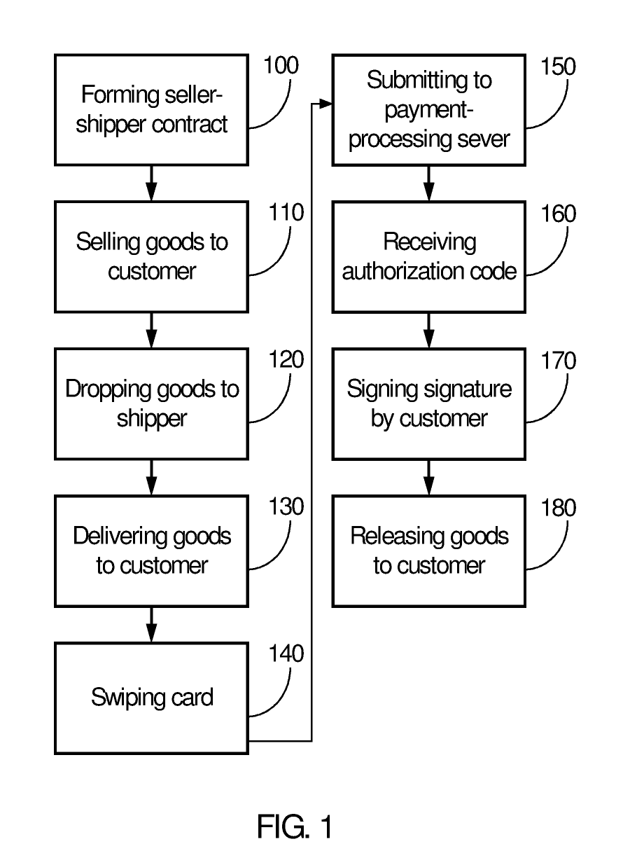

The payment method for accepting credit payment (FIG. 1) at delivery involving a seller, a shipper and a customer and using a handheld device comprises (1) entering into an agreement by a seller and a shipper under which the shipper accepts the credit card, debit card, EBT card and other signature-required payment species on behalf of the seller; (2) selling goods by the seller to the customer by telephone, mail, or Internet with an agreed payment species; (3) dropping off goods by the seller in a proper package at the counter of the shipper; (4) delivering the goods to the customer by a designated delivery person of the shipper; (5) swiping customer's credit card or debit card through the Pads or the slide of the handheld device by the delivery person; (6) entering PIN number if the card is a debit card, or electronic benefits transfers (“EBT”) type if the card is an EBT card; (7) submitting the amount of payment and necessary card information such as card number and expiration date, or debit card number and Personal Identification Number (PIN), or EBT card number, EBT type and its PIN, or checking account routine number and account number to a payment-processing server in the payment network by wireless network access for real-time processing; (7) receiving authorization code from the payment-processing server; (8) signing customer's signature on a signature-capturing pad (which may be transmitted to the payment-processing server or keep it in the RAM memory of the handheld device); and (9) releasing the goods by the delivery person to the customer. Shippers accept credit cards/banks in their normal course of business pursuant to their existing agreements. So, it is may be unnecessary to sign additional agreement for accept credit cards, debit cards, and EBT cards on delivery.

According to the payment method of the present invention, the seller and the shipper enter into an agreement under which the shipper delivers goods and collects money using credit cards and debit cards on behalf of the seller for a fee (block 100). The agreement may be a general agreement or specific agreement for the delivery of the goods. The seller may deliver the goods for other consideration or even no consideration. The invalidity of the agreement will not affect the payment method even though it may make the agreement unenforceable. In the second step (block 110), the seller sells goods to a customer by telephone, regular mail, or Internet, including email and web forms, and agrees with the customer on the amount of payment and acceptable payment species. The seller then affixes the package of the goods with a label, which contains, among other things, the amount of payment and acceptable payment species, and drops off the goods at the counter of the shipper (block 120). Next, the shipper delivers the goods to the customer by a designated delivery person who may be a driver of a delivery truck (block 130), as we commonly see in the common shippers such as United Parcel Services, Fed Express, and other commercial shippers. When the delivery person presents the goods at the door of the customer, the customer swipes a credit card, debit card or EBT card with the Pads or the slide of the handheld device (block 140). If the payment is made using a debit card, the customer is also prompted to enter PIN number. If payment is made by EBT card, the customer is prompted to enter EBT card type and PIN. If the payment is made by a signed check, the delivery person enters the route number and the account number. The delivery person then enters the amount of payment.

After getting all necessary information, the delivery person of the shipper then submits a payment request to a payment-processing server in the payment network by wireless network access for real-time processing (block 150). The payment-processing server then decides whether the payment is approved, and the handheld device receives authorization code or denial message (block 160). Upon receiving authorization code, the customer signs his or her signature on a signature-capturing device (which may be transmitted to a payment-processing server or kept in the memory of the handheld device) (block 170). Finally, the delivery person releases the goods to the customer (block 180). If the payment is not submitted to the payment-processing server, the payment may optionally be submitted for processing after the delivery person releases the goods. A delay in submitting payment may be necessary in some situations, but can cause the shipper to subject to a risk of being unable to collect the money if the credit account is later cancelled, the checking account is closed, or the account from which fund is withdrawn later contains insufficient fund to cover the payment.

Currently, the payment network is sophisticated and can perform all functions necessary to effectuate a payment. Ordering goods by customers by postal mail and phone is generally safe. Ordering goods by Internet, including email and web forms, is secure. Card reading devices are used in all types of sales terminals. By way of example, point-of-sale (POS) payment terminals enable sellers to process payments using credit cards, debit cards, EBT cards, smart cards, checks and other payment methods. Those classic payment terminals usually have a dialup modem connecting to a bank that processes payment transactions. Payment terminals are usually equipped with at least a card reader for reading the data stored in the magnetic stripe of the card. Some payment terminals are equipped with a pin-pad, which allows users to enter a PIN for secure cash transactions. Such transactions include payments made using debit cards, check cards, phone cards, prepaid gift cards, and EBT method. The existing equipment, however, is not suitable for processing payment using a credit card and debit card at the door of customers by a delivery person because they require Internet access using a phone line.

Wireless access technology is a mature technology. Cellular phones can be used in the covered area to reach any number in the United States and overseas. Moreover, data transmitted between a cellular phone and a wireless carrier may be encrypted to issue the safety of the data. When a cellular phone is connected to a server, text strings can be represented in ASCII code, Unicode, or other encoding and voice can be transmitted digitally.

In one embodiment of the present invention, a cellular phone is used to process payment. When the delivery person gets a credit card or a debit card from the customer, he or she dials phone number of the payment-processing server and submits payment request directly from cellular phone to the server. This method is similar to the computerized customer services commonly used by companies. After a connection is established between the cellular phone and the server, the server prompts for card information, and the delivery person manually enters the card number. Then, the server prompts for expiration date, and the delivery person enters expiration date. Finally, the server prompts for amount of payment, and the delivery person enters amount of payment. The server saves the data from each of the prompts for final processing. After all information is received from the cellular phone, the server determines if the payment is approved using database containing credit line of the customer's credit account or fund availability of customer's checking/savings account, and the requested amount of payment. If the payment is approved, the server provides a voice authorization and the customer is asked to sign on a pre-printed payment authorization slip. If the payment is denied, the delivery person may request a different card or an alternative mode of payment.

In the alternative, all payment data may be sent to the server by one single string such as account number-expiration data-amount of payment. For example, if the account number is 2222333344445555, the expiration date is 04/10, and the amount of payment is $243.99, the data for a credit card may be sent in by the string 2222333344445555;04/10;243.99. When this data format is used, the server should have some programming code for parsing and breaking down the data string into respective components. Different delimits may be used by the delivery person as long as the server is programmed to understand. To ensure the safety of the credit information, the communication between the cellular phone and the server should be encrypted. This embodiment of payment method is useful in processing credit card payment and electronic checks only. It cannot be used to process payment that requires a PIN number because the customer cannot disclose PIN to the delivery person.

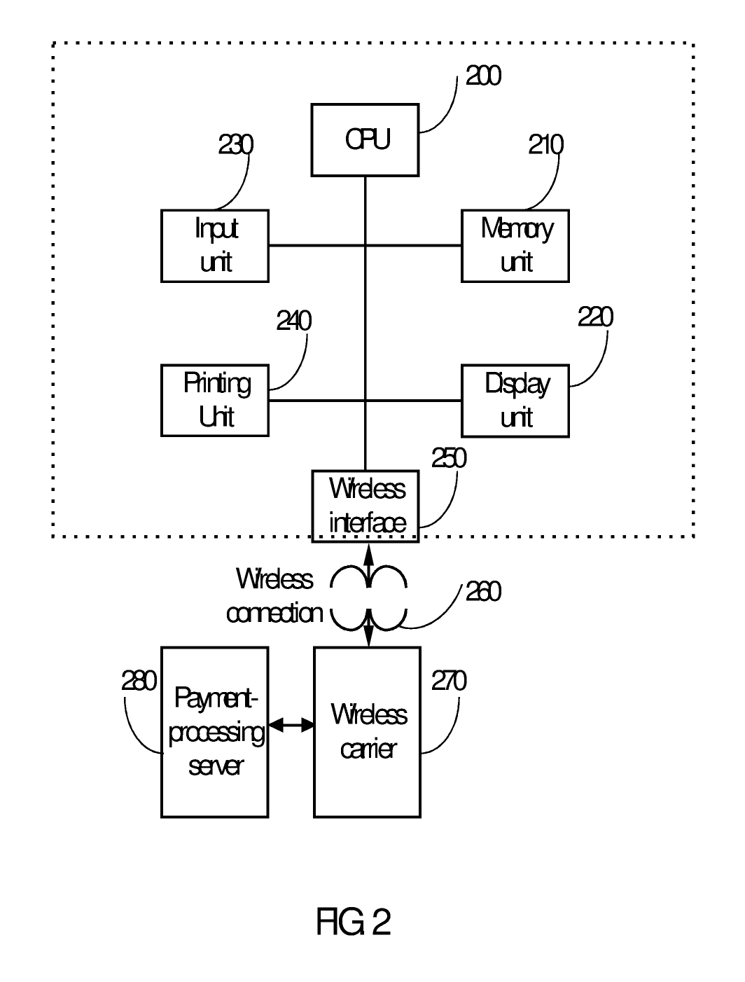

In another embodiment of the present invention, a new handheld device (or payment device) such as a Personal Data Assistant (PDA) is used to scan credit/debit cards data and submit the card data to the payment-processing server of the acquiring bank. PDA's are handheld mobile computer devices that combine computing, Internet, and other networking features. Unlike portable computers, most PDA's use a pen-based stylus for input but may also use a keyboard for input. Some examples of PDA's are Palm and Pocket-PC. The basic components of the handheld device are shown in FIG. 2. The handheld device inside the broken line of the box contains a central processing unit 200, memory unit 210, which includes reading only memory (ROM) and random access memory (RAM), a display unit 220, which includes a display and a necessary adapter, an input unit 230, which includes scanning hardware, some key button and necessary controller, and a wireless interface 250, which includes a wireless modem or equivalents and a necessary controller. All units of the handheld device are connected by a data bus, which is denoted by straight lines connecting the units. The handheld device may optionally contain a printing unit 240, which includes printing parts and an input/output controller, for printing payment receipts. The printing unit 240 is optional because receipts may be prepared and placed inside the package of the goods before the goods are shipped.

The ROM of the memory unit 210 may contain code for running the handheld device just like computer BIOS. The display unit 220 may be programmed to show the status of the handheld device such as message for prompting input data and displaying waiting period after a payment is submitted to the payment-processing server 280. The display unit 220 may echo back the data entered from except PIN. The RAM component of the memory unit 220 is useful in storing code and application data such as amount of payment and card/account information before the handheld device sends out the payment request.

Through the wireless interface 250, the handheld device is connected to the wireless carrier 270 by a wireless connection 260. By using wire (or wireless) connection between the wireless carrier 270 and the payment-processing server 280, the handheld device can exchange data with the payment-processing server 280 of an acquiring bank. The wireless carrier 270 may be any commercial wireless carrier such as Sprint, Cincular, T-mobile, Nextel, Verizon, and AT&T wireless as long as the carrier has a covered wireless service at the location of delivery. The wireless connection 260 may be any of a number of available wireless connection communications such as Code-Division Multiple Access (CDMA) and General Packet Radio Service (GPRS). After a successful connection is established, the handheld device sends a payment request to the payment-processing server 280 according to HTTP standard (such as HTTP/1.0 and HTTP/1.1), FTP standard, or other private standard that is recognized by both the handheld device and the payment-processing server. If an HTTP standard is used, the payment request must contain a header file and a data body that contains card information and amount of payment in proper secure format. The secure format may be the Secure Sockets Layer (SSL) protocol. The SSL encryption would be a combination of both RSA encryption, an asymmetric algorithm for stronger protection, and TripleDES (3DES) encryption, a symmetric algorithm for speedy encryption. SSL would use RSA encryption for securing the session key exchange and TripeDES for the actual encryption.

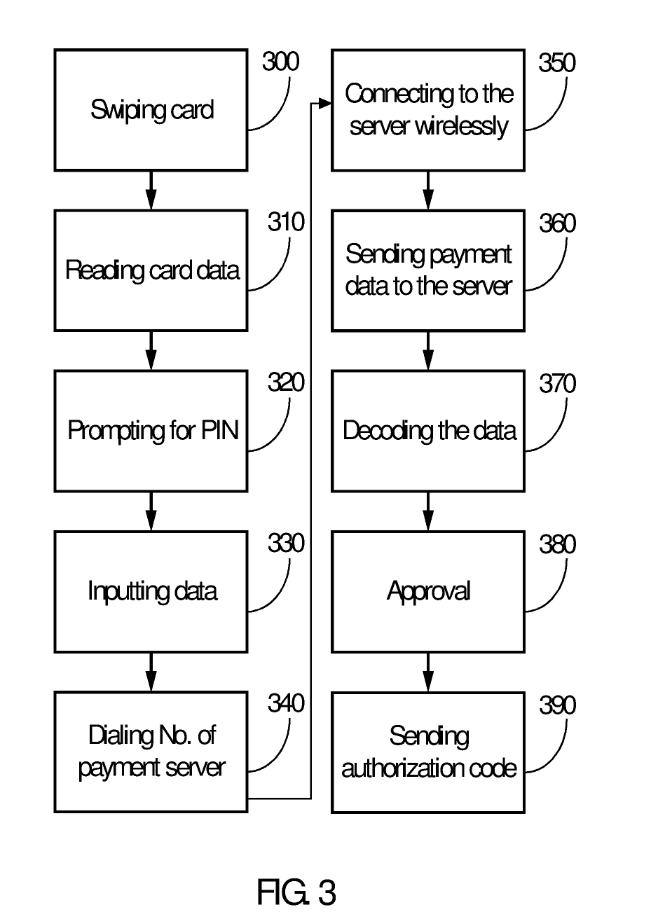

After the handheld device is powered on, the detailed steps for performing functions are shown in FIG. 3. First, the delivery person or the customer swipes a card through the slide (block 300). The handheld device then reads card data (block 310) and displays a message for prompting for PIN if the card is a debit card or EBT card type and its PIN if the card is an EBT card (block 320). The prompt message is shown in the display (not shown in FIG. 3). The customer then enters a PIN or EBT card type, and the delivery person enters the amount of payment, which should be echoed back in the display (not shown). After all necessary data is entered, the delivery person pushes a submission button, which triggers the dialing of the wireless modem (block 340). The handheld device is then connected to the payment-processing server of an acquiring bank (block 350). After successful connection is established, the handheld device sends a payment request to the payment-processing server (block 360) according to HTTP standard (such as HTTP/1.0 and HTTP/1.1), FTP standard or other private standard that is recognized by both the handheld device and the payment-processing server. If an HTTP standard is used, the payment request must contain a header file and a data body that contains card information and amount of payment. The payment request should be sent preferentially in a proper secured format. The data in the request body should be encrypted.

The server then decodes the body of the payment request (block 370) and extracts amount of payment and the card information or other necessary information for debit card, EBT card, and check-present electronic check. The server than access the database concerning account standing, credit line in light of the amount of payment to determine if payment request should be approved (block 380). If the payment is a debit card or an electronic check, the server also determines if sufficient fund is available. Upon approval, the server returns authorization code or denial message to the handheld device (block 390). The handheld device may retain a copy of the captured customer signature in the RAM for record. Optionally, the handheld device may send a copy of the captured signature to the server for record. The handheld device may incorporate the functions of pin-pads, signature-capturing pads, and receipt printers. It is preferable that the device is small and light enough for the convenience of the delivery person.

To increase the security of credit information, data communication between the handheld device and the payment-processing server may be encrypted according to any of the prevalent encryption methods. SSL 128-bit encryption is a standard method in Internet. The same technology may be used in wireless connection.

In those exemplary embodiments of the present invention, specific components, hardware parts, arrangements, and processes are used to describe the invention. Obvious changes, modifications, and substitutions may be made by those skilled in the art to achieve the same purpose of the invention. The exemplary embodiments are, of course, merely examples and are not intended to limit the scope of the invention. It is intended that the present invention include all other embodiments that are within the scope of the claims and their equivalents.

What is claimed is:

1. A payment method of using a wireless handheld device and a wirelessly connected payment-processing server for processing a card payment at delivery of goods real time, the handheld device, the method comprising:
entering into an agreement by a seller and a shipper under which the shipper accepts the credit card and debit card on behalf of the seller;
selling goods by the seller to the customer by telephone, mail, or Internet with an agreed payment method and acceptable species;
dropping off goods by the seller in a proper package at the counter of the shipper;
delivering the goods to the customer by a designated delivery person of the shipper;
swiping customer's credit card or debit card through the slide of the input unit by the delivery person;
prompting and entering necessary card information and the amount of payment;
submitting the card information and amount of payment to a payment-processing server in the payment network by wireless network access for real-time processing;
approving the payment request by the payment-processing server;
receiving authorization code by the handheld device from the payment-processing server;
signing a signature by the customer on a signature-capturing device; and
releasing the goods by the delivery person to the customer.

2. The payment method of claim 1 wherein the card is a debit card and the information customer entered is a PIN and amount of payment.

3. The payment method of claim 2 further comprising a step of printing a payment authorization receipt.

4. The payment method of claim 2 further comprising transmitting a copy of the captured customer signature to the payment-processing server.

5. The payment method of claim 1 wherein the card is a credit card and the information entered is amount of payment.

6. The payment method of claim 1 wherein the card is an EBT card and the information customer entered is type of the card, amount of payment and a PIN.

7. The payment method of claim 1 further comprising a step of printing a payment authorization receipt.

8. The payment method of claim 1 further comprising transmitting a copy of the captured customer signature to the payment-processing server.

9. A payment method of using a cellular phone and a remotely connected payment-processing server for processing a payment using a credit card or electronic check at delivery of goods real time, the method comprising:
entering into an agreement by a seller and a shipper under which the shipper accepts the credit card and a check on behalf of the seller;
selling goods by the seller to the customer by telephone, mail, or Internet with an agreed payment species;
dropping off goods by the seller in a proper package at the counter of the shipper;
delivering the goods to the customer by a designated delivery person of the shipper;
dialing the number of the payment-processing server by the delivery person using the cellular phone;
prompting and account information of the credit card or the checking account and the amount of payment by the server;
entering the prompted account information and amount of payment to the cellular phone for transmission;
approving the payment and sending authorization code by the payment-processing server if the payment is approved;
receiving authorization code by the cellular phone from the payment-processing server;
signing signature by the customer on a preprinted payment authorization slip; and
releasing the goods by the delivery person to the customer.

10. The payment method of claim 9 wherein the payment is made using a credit card.

11. The payment method of claim 9 wherein the payment is made using a check drawn on a checking account.

12. A payment device for processing signature-required payment at delivery of goods real time using a wirelessly connected payment-processing server in the payment network, the device comprising the steps of:
a central processing unit being connected to a data bus for processing data;
a memory unit being connected to the data bus, the memory unit containing read-only memory and random access memory, the read-only memory containing basic operating code for running the handheld device, the random access memory holding application data;
an input unit being connected to the data bus for reading card information and inputting data, the input unit comprising a card slide and key buttons and being capable of reading card information from the magnetic stripe of a card passing through the slide and sending the card data to the data processing unit for processing according to the instruction of operating code;
a displaying unit for displaying processing status, authorization code and denial message, input prompts, connection status, and power level of the battery; and
a wireless interface for accessing the payment-processing server of the acquiring bank,
Whereby upon pressing on a submission button, the handheld device is able to connect to the payment-processing server by the wireless interface and transmit the payment data to the payment-processing server for approval and is able to receive authorization code or denial message from the payment-processing server for display.

13. The payment device of claim 12 wherein the handheld device is able to encrypt the data sent to and received from the payment-processing server.

14. The payment device of claim 12 further comprising a printing unit for printing a payment authorization slip.
